(19) United States
(12) Patent Application Publication
(10) Pub. No.: US 2010/0064080 A1
(43) Pub. Date: Mar. 11, 2010

(54) MANAGING PCI-EXPRESS MAX PAYLOAD SIZE FOR LEGACY OPERATING SYSTEMS

(75) Inventors: Mehul Shah, Austin, TX (US); Ryuji Orita, Redmond, WA (US); Sandra D. Rhodes, Wake Forest, NC (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/208,640

(22) Filed: Sep. 11, 2008

(51) Int. Cl. G06F 13/42

(52) U.S. Cl. 710/105

(57) ABSTRACT

The present disclosure is directed to a method for balancing latency versus bandwidth trade-offs in packet transmission utilizing PCI-Express. The method may comprise identifying at least one system element along a path of a packet to be transmitted; determining and storing an optimum payload size for each one of the at least one system element; configuring a Max Payload Size parameter for each one of the at least one system element, wherein the Max Payload Size parameter is configured based on the optimum payload size for each one of the at least one system element.

### TECHNICAL FIELD

The present disclosure generally relates to the field of computer science, and more particularly to a method for balancing latency versus bandwidth trade-offs.

### BACKGROUND

When transmitting packets utilizing PCI-Express, a Max Payload Size mechanism may be configured by software to control the maximum payload in the packets to be transmitted between endpoints to balance latency versus bandwidth trade-offs. If multiple system elements are involved along the path of the packets, the software may configure the Max Payload Size parameter of each system element to a non-default value. In such case, the software is responsible to ensure that each packet does not exceed the Max Payload Size parameter of the system elements along the path of the packet. Failure to do so may cause the packet to be rejected by a system element whose Max Payload Size parameter is smaller than the size of the packet.

### SUMMARY

The present disclosure is directed to a method for balancing latency versus bandwidth trade-offs in packet transmission utilizing PCI-Express. The method may comprise identifying at least one system element along a path of a packet to be transmitted; determining and storing an optimum payload size for each one of the at least one system element; configuring a Max Payload Size parameter for each one of the at least one system element, wherein the Max Payload Size parameter is configured based on the optimum payload size for each one of the at least one system element.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for balancing latency versus bandwidth trade-offs.

### DETAILED DESCRIPTION

Reference will now be made in detail to the subject matter disclosed, which is illustrated in the accompanying drawings.

A system firmware may be responsible for ensuring that no packet exceeds the Max Payload Size parameter of the system elements along the path of the transmitting packet in an operating system. If the operating system is a legacy operating systems, the firmware may be configured to avoid programming a Max Payload Size above the default of 128 bytes, which is the minimum payload size supported by all system elements. This is because the legacy operating system may not comprehend PCI-Express, and may support system elements that perform internal reset.

For example, a system element in a legacy operating system may perform an internal reset upon transitioning from D3hot state to D0 state via software control of the PowerState bits. Configuration context may be lost when performing the reset. Upon transition from D3hot state to D0 state, full re-initialization sequence may be needed to return the system element to D0 initialized. However, the legacy operating system may not be aware of the PCI-Express features such as the Max Payload Size mechanism, and may not save/restore any PCI-Express configuration during transition to D3hot/D0 state. Therefore, the Max Payload Size parameter may be reset to the default of 128 bytes whenever the system element comes out of a low power state.

The present disclosure is directed to a method for balancing latency versus bandwidth trade-offs. The method may configure the Max Payload Size parameter of each system element along the path of a transmitting packet to a non-default value. The non-default value for each system element is configured utilizing an optimum payload size determined based on the capability of each system element.

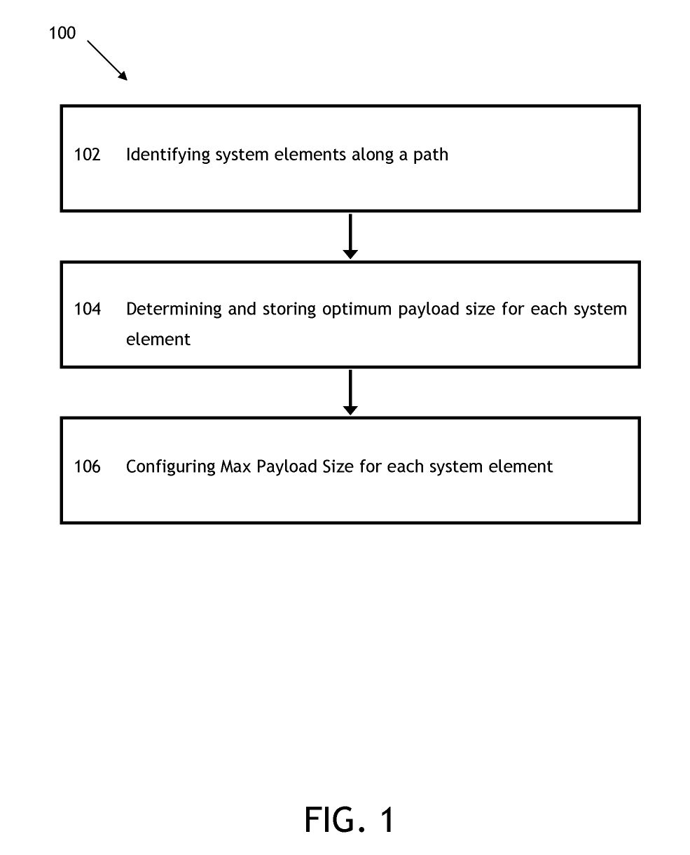

FIG. 1 shows a flow diagram illustrating steps performed by a method 100 in accordance with the present disclosure. Step 102 identifies the system elements along the path of a packet to be transmitted. Step 104 determines and stores an optimum payload size for each one of the system elements identified. For example, if a first system element and a second system element along the path are capable of transmitting payload of size up to 1024 bytes and 256 bytes, respectively, the optimum payload size for the first system element and the second system element may be determined to be 1024 bytes and 256 bytes, respectively. Step 106 configures the Max Payload Size parameter for each system element based on the optimum payload size determined in step 104. In the example stated above, the Max Payload Size parameter for the first system element may be configured to be 1024 bytes, and the Max Payload Size parameter for the second system element may be configured to be 256 bytes.

In one embodiment, the Max Payload Size parameters, along with other applicable configuration context, may be stored and/or restored on device drivers of the corresponding system elements. For example, during the transition from D3 state to D0 state, the Max Payload Size parameters may be determined and stored to the corresponding device drivers; during the transition from D0 state to D3 state, the Max Payload Size parameters stored in the corresponding device drivers may be retrieved and restored. It is contemplated that during the installation of a device driver, the device may require a system reboot prior to allowing a direct memory access (DMA) operation to be performed by the device. This is because the operating system may have the device in D3 state when the device driver is installed.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for balancing latency versus bandwidth trade-offs in packet transmission utilizing PCI-Express, comprising:
identifying at least one system element along a path of a packet to be transmitted;
determining and storing an optimum payload size for each one of the at least one system element;
configuring a Max Payload Size parameter for each one of the at least one system element,
wherein the Max Payload Size parameter is configured based on the optimum payload size for each one of the at least one system element.
